(19) United States
(12) Patent Application Publication
(10) Pub. No.: US 2010/0014510 A1
(43) Pub. Date: Jan. 21, 2010

(54) PACKET BASED COMMUNICATIONS

(75) Inventors: Roksana Boreli, New South Wales (AU); Terence Michael Paul Percival, New South Wales (AU)

Correspondence Address: SNELL & WILMER LLP (OC), 600 ANTON BOULEVARD, SUITE 1400, COSTA MESA, CA, 92626, US

(73) Assignee: NATIONAL ICT AUSTRALIA LIMITED, Eveleigh, NSW (AU)

(21) Appl. No.: 12/298,123

(22) PCT Filed: Apr. 11, 2007
(86) PCT No.: PCT/AU07/00482

§ 371 Date: May 5, 2009

(30) Foreign Application Priority Data
Apr. 28, 2006 (AU) 2006902220

(51) Int. Cl. H04L 12/66

(52) U.S. Cl. 370/352

(57) ABSTRACT

This invention is applicable to packet based, rate limited radio links, such as satellite or terrestrial wireless digital communications systems. These communications networks concurrently carry time-critical traffic, such as voice or multimedia, and non time-critical traffic, such as generic data traffic, between two or more communication end points. The communication end points may be connected through a number of heterogenous networks and the end to end throughput characteristics may vary over time. A first aspect of the invention concerns a method for generating packets. In other aspects the invention concerns a computer system for use in packet based communications, a computer protocol for packet based communications and a communications packet. The invention involves determining a “time slice” packet size from the link speed and the interval of time extending between the times at which packets are selected for output from a buffer to the transmission interface. It also involves creating a network packet from frames of time-critical data generated during the interval, where the packet is synchronised to both existing timing requirements of the time-critical frames and the link speed. Then, adding non time-critical data to the network packet if its size had not exceeded the determined “time slice” packet size.

### TECHNICAL FIELD

This invention is applicable to packet based, rate limited radio links, such as satellite or terrestrial wireless digital communications systems. These communications networks concurrently carry time-critical traffic, such as voice or multimedia, and non time-critical traffic, such as generic data traffic, between two or more communication end points. The communication end points may be connected through a number of heterogenous networks and the end to end throughput characteristics may vary over time. A first aspect of the invention concerns a method for generating packets. In other aspects the invention concerns a computer system for use in packet based communications, a computer protocol for packet based communications and a communications packet.

### BACKGROUND ART

State of the art packet based communications systems transmit a combination of time-critical traffic, and non time-critical traffic between two or more communication end points; see FIG. 1. The time-critical and non time-critical traffic are combined at the network packet level. For example, in the case where Internet Protocol (IP) telephony and generic data communications traffic share the same IP infrastructure, dedicated voice IP packets and dedicated data IP packets are used to transmit voice and data respectively.

Each network packet consist of a payload and a header; see FIG. 2. The payload contains application data, which may be either time-critical or non time-critical data, and a header. The header generally contains information relating to the network layer and higher layer functions, such as originating point, destination end point, parameters and other material.

In many cases, time-critical traffic is generated from a continuous analog signal. Speech for instance is converted into an analog waveform by a microphone. These waveforms are digitised by an analogue to digital (A/D) converter and then encoded by a voice codec (coder/decoder) into (voice) data frames. Each voice data frame consists of a specified number of bits representing the relevant characteristics of the voice frames. For the majority of voice codecs the data frame time duration is constant.

A header containing a time stamp (T) is added to all the data frames; see FIG. 3.

When a single voice stream is being transmitted over the link, one or more voice data frames can be concatenated into a single network packet. Where two or more voice streams are to be transmitted over the same link, the voice frames can be combined by multiplexing into the one network packet. In the example shown in FIG. 4, two streams of data frames 1 and 2 are multiplexed with a multiplexing frame rate at half the codec frame rate. A meta-frame timing header (MT) may also be added to the multiplexed stream of data frames.

IP telephony solutions based on the Voice over Internet Protocol (VoIP) commonly use the Real Time-Transport Protocol (RTP), the User Datagram protocol (UDP) and the Internet Protocol (IP). These protocols are also added to the multiplexed packets to result in the packet structure shown in FIG. 5. It will be understood that it is necessary to transmit voice packets at close to the codec frame generating rate. Also, when efficient voice codecs are used, that do not generate a large amount of data per single voice frame, the combined IP, UDP and RTP header may be close to or larger than the IP packet payload. As a result there is a high ratio of packet overhead to payload transmission. This inefficiency is especially a problem for low bit rate communications channels.

Some systems attempt to overcome the overhead inefficiency problem by using header compression (HC) techniques. When the two communication end points are connected by a number of heterogenous networks, the packets will need to traverse routing equipment, which needs to examine the network packet headers to determine the destination, origin and possibly other information included in standard network headers. Unless especially equipped with the appropriate decompression technology the routing equipment will not be able to read the information in the packets which have compressed headers, and this will prevent those packets from reaching their destination. Consequently this solution to the overhead inefficiency problem requires all the network routing equipment to have the same HC implementation [1].

An alternative proposal for overcoming the overhead efficiency problem is to multiplex several voice sessions into one stream, or to include multiple frames from a single conversation into a single network packet. The latter method results in increased variation in the delay of the received voice frames (arising from random delays in the intermediate network points), called packet network jitter, and this reduces the perceived quality of voice in IP telephony.

FIG. 6 is a block diagram of a state of the art packet system for transmitting several voice channels over a packet network.

The problems described above are all exacerbated when non time-critical data is to be transmitted along with VoIP packets. Non time-critical data may be generated from a digital source which produces a stream of bits. The stream of bits is then divided into packet payloads having a specified size or range of sizes. The payload size for data packets is generally larger than the payload size of voice, or other time-critical data, packets; as illustrated in FIG. 7. However, as can be seen in FIG. 7 the size of the packet header remains the same.

When voice and data are transmitted in separate network packets priority queuing is used to counteract jitter problems. Priority queuing employs a priority buffer that receives and stores packets awaiting transmission. At pre-determined regular intervals the buffer outputs packets to the transmission interface, and because it gives priority to the voice packets these are sent before the data packets.

At a time when no voice packets are available, the priority buffer will output data packets. However, during the time periods when a data packet is being transmitted, new voice packets entering the buffer cannot be transmitted until the current data packet has finished being transmitted. This is a second source of jitter, called transmission jitter, related to the data (network) packet size and the transmission (link) speed. The maximum overall jitter amount is determined by the maximum transmission jitter plus the packet network jitter Jₙ. The maximum jitter Jₘₐₓ is:

Jₘₐₓ=maximum network (data) packet size/Link speed+Jₙ

The maximum transmission jitter can be reduced by reducing the maximum data payload, and in state of the art systems this is achieved by packet segmentation, see for example [4], as illustrated in FIG. 8. In any event the network packets must not exceed the largest physical size (measured in bytes) that the network is capable of transmitting, know as the Maximum Transmission Unit (MTU).

Time Division Multiplexing (TDM) over IP is another technique and is used for transmitting circuit switched bearers over digital links [2]. It is a circuit emulation technology that extends voice, video or data circuits across packet switched networks. TDMoIP uses a fixed structure of voice and data frames which form the payload of the IP packets. Therefore, each IP packet consists of one or more encapsulated E1 (or T1) frames.

### SUMMARY OF THE INVENTION

In a first aspect, the invention is a method of generating packets for transmission over a packet based communications network, the method comprising the steps of:
Determining a “time slice” packet size from the link speed and the interval of time extending between the times at which packets are selected for output from a buffer to the transmission interface.
Creating a network packet from frames of time-critical data generated during the interval, where the packet is synchronised to both existing timing requirements of the time-critical frames and the link speed.
Then, adding non time-critical data to the network packet if its size had not exceeded the determined “time slice” packet size.

The invention combines the time-critical and non time-critical traffic streams in the same payload below the network packet level, and before forming IP packets.

The time-critical data may be voice data.

The non time-critical data, may be a data stream, an existing network packet data stream (such as), website or email traffic, or any other data source.

The packet based communications system may be a computer network that includes a transmission link that is via a satellite or some other rate limited radio channel.

The packets may be Internet Protocol (IP) packets.

Since the invention combines the time-critical and non time-critical traffic prior to including this traffic in the network packet payload, it increases the payload to header ratio.

The “time slice” packet size may be calculated from a running mean of the speed of the transmission of data across the network between the two end points (or link speed), and as a result the “time slice” packet size may be dynamically adjusted to current network conditions. Alternatively, the time slice may be estimated by a predictive technique which may include a feedback component.

The time-critical and non time-critical communications may also be prioritised according to a priority queue.

The invention is able to increase the efficiency of packet based time-critical traffic (such as, IP telephony) in terms of the size of packet header to payload ratio.

In systems which combine multiple input streams of time-critical traffic (such as, combining a number of voice conversations in IP telephony), the invention also decreases the jitter, that is the variation in the delay of the received time critical traffic.

The invention also provides an end-to-end system which is transparent to any standard intermediate network points and which requires no additional or custom technology to be available in these points. As a result the invention is easy to implement when compared to various header compression technologies, as it can be used without any changes in the network equipment (e.g. to read compressed header information).

In another aspect, the invention provides a computer system for transmitting packets on a packet based communications system, wherein:
“Time slice” packet size is dynamically determined from the link speed and the interval of time extending between the times at which packets are selected for output from a buffer to the transmission interface.
Network packets are constructed from frames of time-critical data generated during the interval, where the packets are synchronised to both existing timing requirements of the time-critical frames and the link speed. Then,
non time-critical data is added to the network packet if its size had not exceeded the determined “time slice” packet size.

In a further aspect, the invention is computer software for generating packets for transmission on a packet based communications system as defined by the method described above.

In yet further aspect, the invention is a communications packet generated by the method, where the packet contains both time-critical and non time-critical data.

The invention is designed for use in burst or packet mode, but not continuous, communications systems, where the end to end throughput is not constant due to other traffic sharing one or more of the transmission links that comprise the end to end connection. The invention may improve throughput by reducing the effect of the overhead resulting from relatively large data packet headers. Each packet sent can contain both time critical and non-time critical data.

The invention may also reduce jitter time, resulting from the speed of the link, which varies from situation to situation and dynamically changes during a session. This improvement is particularly welcome in the presence of long round trip delays.

Non-critical data transmission can also be interrupted if time critical data becomes available for transmission; which is also important where there are long round trip delays such as satellite links.

### BRIEF DESCRIPTION OF THE DRAWINGS

The background art is described with reference to the following drawings, in which:

FIG. 1 is a block diagram of a state of the art packet based communications network.

FIG. 2 is a diagram showing the network packet structure.

FIG. 3 is a diagram showing voice codec frames.

FIG. 4 is a diagram showing a multiplexed voice coded frame.

FIG. 5 is a diagram showing a network packet frame structure.

FIG. 6 is a flow chart showing state of the art IP telephony.

FIG. 7 is a diagram showing network packets for voice and data traffic.

FIG. 8 is a diagram illustrating segmentation applied to data packets bigger than the maximum transmission unit (MTU).

An example of the invention will now be described with reference to the accompanying drawings, in which:

FIG. 9 is a diagram of a “time slice”.

FIG. 10 is a diagram showing a “time slice” packet structure.

FIG. 11 is a diagram illustrating link speed.

FIG. 12 is a flowchart of packet payload filling.

FIG. 13 is a diagram illustrating priority queuing.

FIG. 14 is a diagram of a network packet in a “time slice” system.

FIG. 15(a) is a diagram of a point to point communications system, and FIG. 15(b) is a diagram of a point to multipoint communications system.

### BEST MODE OF THE INVENTION

In this example we use the concept of a “time slice” which is defined to be the reciprocal of the network packet transmission rate.

The “time slice” duration is dependent on the number (n) of voice frames that can be generated by a voice codec during the “time slice”:

Time slice duration Tₛₗ=n*voice codec time frame duration.

A “time slice” packet is assembled from the data, both time-critical (voice) and non time-critical (data) produced during a “time slice”, plus a header.

The “time slice” packets are synchronised with both the existing timing of the time-critical communications, that is the voice (audio) codec time frame duration; and, with the link speed, that is the available end to end communication speed between the two communication end points. As a result the optimum “time slice” packet size can be calculated from:

Time slice packet size=link speed*Time slice duration

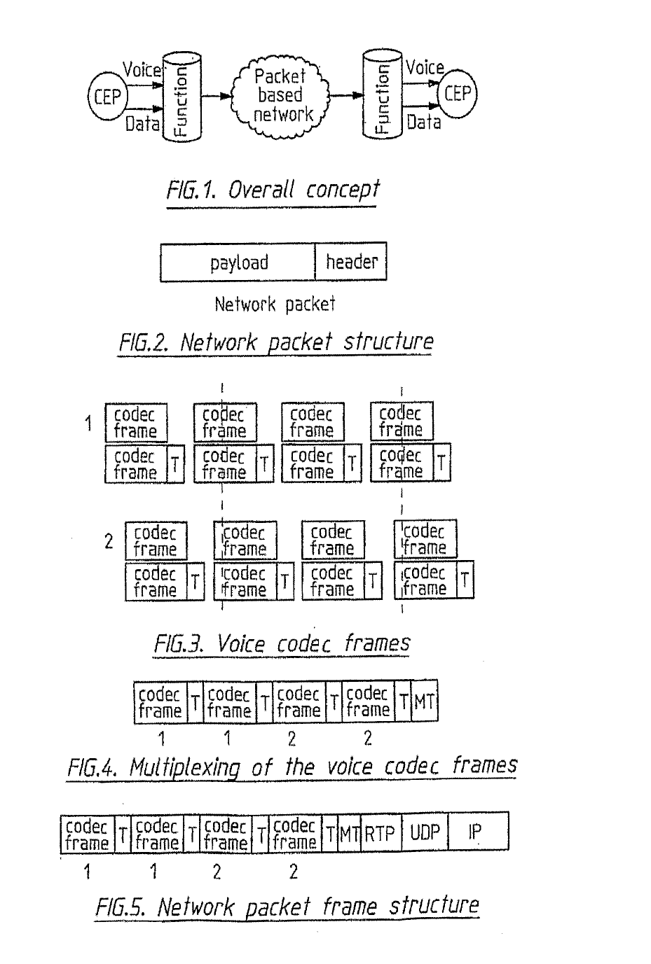

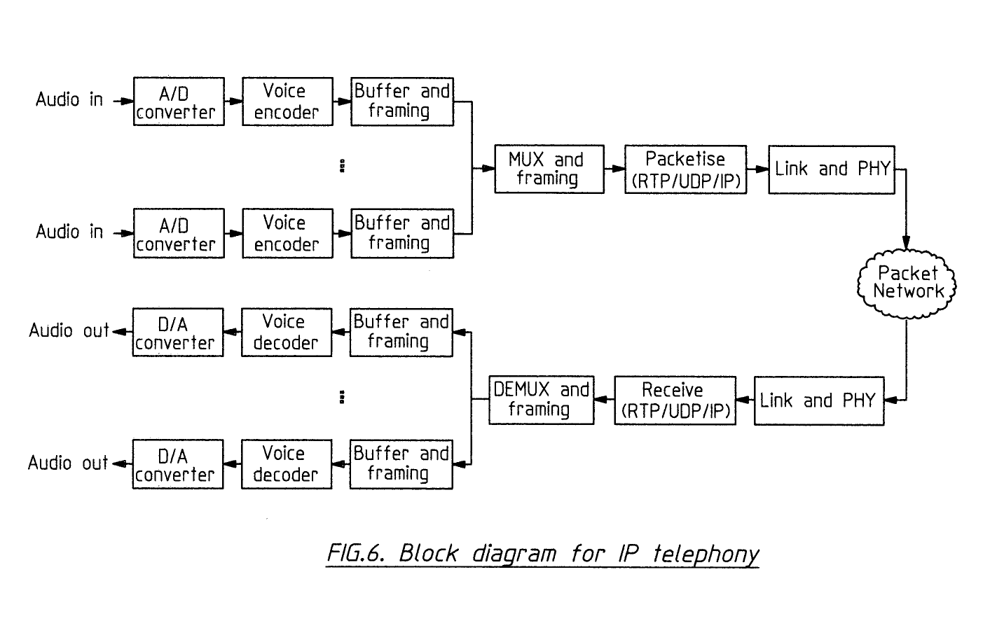

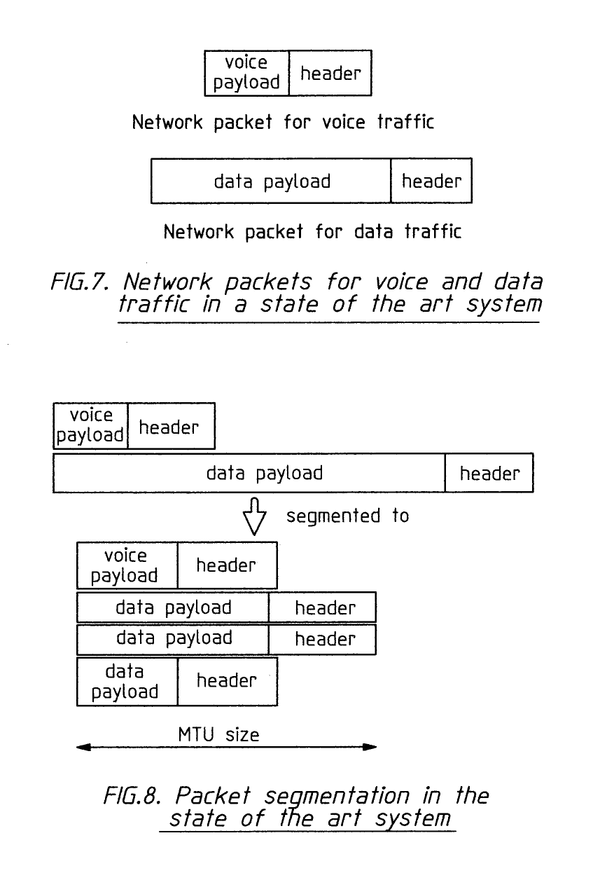

The “time slice” packet has a structure determined by the network packet structure, and it will generally consist of a payload and a header, as depicted in FIG. 2. Since the header size is generally pre-determined, the size of the “time slice” packet payload can be easily calculated by:

Time slice packet payload size=Time slice packet size−header size

The size of the “time slice” packet payload that is to be assembled in any “time slice” is calculated from the equations above, and if this is greater than the payload generated by all the voice frames during the “time slice”, then data traffic can be added to the payload of the packet.

An example of the “time slice” calculations is presented below, given the following conditions:
Voice codec frame duration=20 ms
Voice codec frame produces 15 bytes of data
Time slice duration=40 ms
Current average link speed=200 kbit/s
Time slice packet size=8000 bits=1000 bytes
MTU size is 1500 bytes
There are 10 simultaneous voice conversations.

Since each voice codec produces 15 bytes per 20 ms frame, with 10 voice conversations and a Time slice of 40 ms, there are calculated to be equals 300 bytes of voice per payload. The Time slice packet size is 1000 bytes, hence there is 700 bytes of available space for data frames.

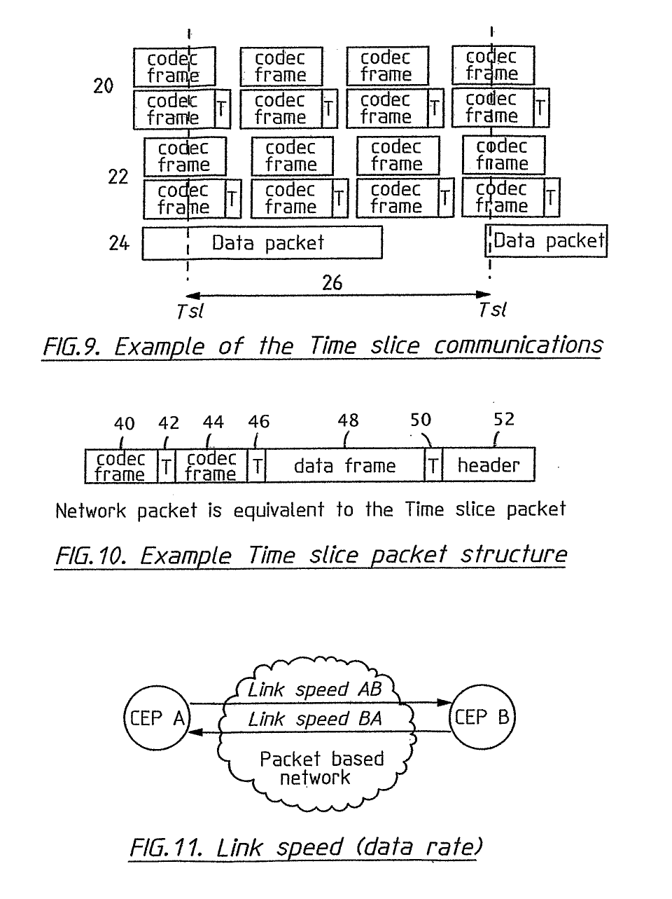

FIG. 9 shows an example where there are two parallel voice communications 20 and 22 and a data communication stream 24 in a “time slice” 26. The voice codec frames are generated from the codec in the usual manner and are packed into a “time slice” packet. In this case the amount of data from the voice codec frames is not sufficient to fill in the available payload in the “time slice” packet, and so data from the data stream 24 is also added to the “time slice” packet.

The contents of the resulting “time slice” packet is shown in FIG. 10. There is a first voice frame 40 from the first voice communication with its header 42, a second voice frame 44 from the second voice communication with its header 46, and part 48 of the data stream 24 with its header 50. The headers 42, 46 and 50 contain information which allows the separation and identification of the voice and data information.

In FIG. 10, the “time slice” packet could be transmitted as a network packet with a payload consisting of additional sub-framing information bits and a time stamp. If it were a network packet it would also include a network packet header 52.

In a multi-user packet based communications system the link speed obtained between two end points is variable depending upon the traffic load of the other users. Referring to FIG. 1, the link speed between two communication end points A and B can be estimated provided the communication end points will either synchronise local clocks or be connected to the Universal clock (from network time). For example, if each transmitted packet includes a time stamp which is inserted before transmission, the travel time Δt of the packet between the end points A and B can be derived. The transmitted “time slice” packet size is also known. As a result we can estimate the link speed as follows:

Link speed AB [bit/s]=Time slice packet size/Δt

(or Time slice packet size [bytes]*8/Δt)

A moving average (running mean) of the link speed may be calculated as follows: For every instance (k) of the calculated link speed, an average link speed is calculated based on the i previous link speed instances.

Average link speed [k]=Average link speed [k−1]+1/i(Link speed [k]−Link speed [k−i])

where i is an integer value which needs to be adapted to the variability of the link speed of the network.

From the running mean a continually updated “time slice” packet size can be estimated, which is dynamically adjusted to the network conditions, as:

Time slice packet size=Average link speed [bit/s]*Time slice[s] or

(Time slice packet size [bytes]=Average link speed [bit/s]/8*Time slice[s])

In practice the resulting “time slice” packet size, although it will never be more than optimum, will sometimes exceed the size of the MTU and need segmentation.

The MTU size for limiting of the maximum “time slice” packet size can be found by using one of the existing state of the art protocols, e.g. the ICMP Path MTU Discovery Protocol [3]. If the calculated Time slice packet size is greater than the MTU size, the packet is split into an integer number of MTU sized packets.

number of packets=INT(packet size/MTU size)

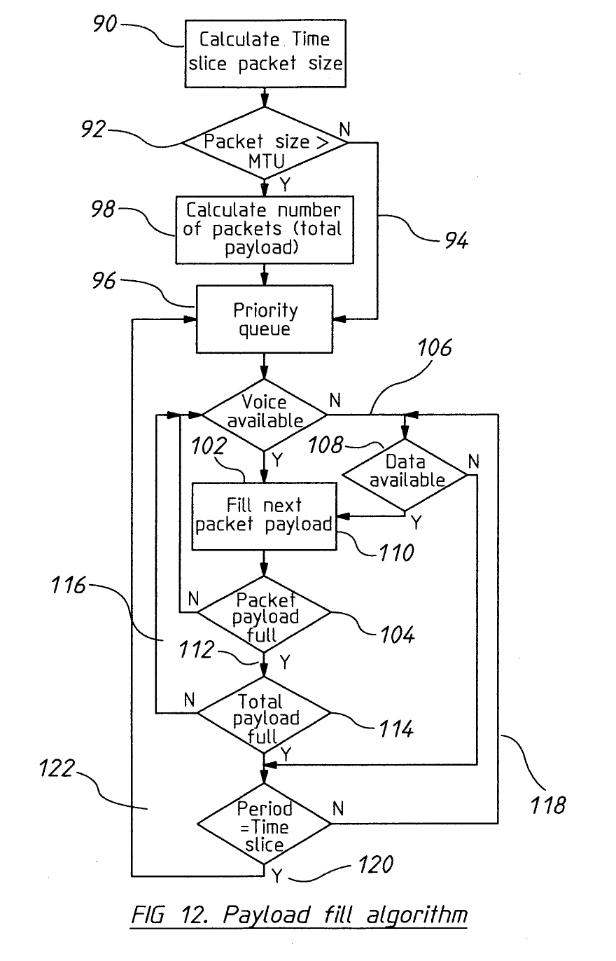

Referring now to FIG. 12, the first step towards filling the payload of a Time slice packet is to calculate the size of the current “time slice” packet 90 to determine whether it exceeds the MTU or not. The “time slice” packet size is dynamically calculated as above.

The “time slice” packet size is then compared with the MTU 92. In the event that the “time slice” packet size is not greater than the MTU, the contents of the “time slice” packet are sent 94 directly to priority queue 96.

At the priority queue 96, if the size of the “time slice” packet, which contains only voice frames does exceed the maximum payload determined by the MTU then data traffic can be added to the payload of the network packet that is assembled for transmission.

When the “time slice” packet size exceeds the MTU, it is necessary to calculate the number of network packets 98 that will be required to carry the payload of the “time slice” packet, The “time slice” packet payload is then divided accordingly and the parts sent to priority queue 96.

In either event, the network packets are filled as follows:
After the beginning of the “time slice” the first voice frame arriving in the priority queue 96 is loaded 102 (as payload) into a network packet.
After the voice frame has been loaded 102 the network packet is tested to determine whether it is full, or not, 104. If not the next voice frame is loaded.
If the packet is not full but no voice frames are waiting to be loaded 106, then a check is made to determine whether there is any data available 108.
If so then the packet payload is filled with that data 110 until the MTU is reached.
When the packet is full 112 a check is made to determine whether the Total payload for that transmission has yet been reached 114.
If not a check is made to determine whether there is any more voice or data 116 and the next network packet is filled as before.
If the Total payload is reached no more packets are filled.
If there is no voice and no data then checking 118 for new data in the priority queue continues until the Time slice ends 120.
At the end of the Time slice 120 packets are selected for transmission from the priority buffer, with voice frames taking precedence over data, and the process of filling packets begins again 122.

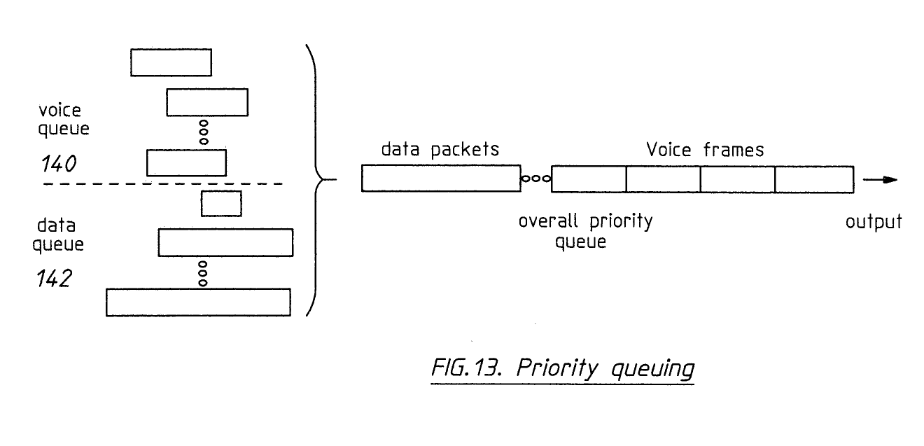

FIG. 13 illustrates the process of assembling of the network packet payload. It involves presenting a voice queue 140 and a data queue 142 and then taking the voice packets first and filling spare capacity with data stream. It should be appreciated that some of the voice packets will contain data but this does not affect their preferential selection. The resulting network packet is shown in FIG. 14.

Only data traffic will be transmitted when there are no available voice frames in the priority buffer.

When compared to state of the art systems that multiplex voice codec frames from one or more simultaneous conversations, the invention is able to provide superior jitter performance while keeping the same size jitter buffer in the receiver. Jitter is bounded by the size of the “time slice” packet and the MTU, which will always be smaller than the maximum network packet size. Also, since packet size is linked to the timing of the time-critical traffic the maximum jitter Jₘₐₓ is, in the “time slice” case is:

Jₘₐₓ=Time slice packet size/Link speed+Jₙ=Tₛₗ+Jₙ

This reduced jitter results in improved voice quality at the receiver.

Generally, the data frames are significantly larger than the voice frames. A further improvement in performance can be obtained by terminating the transmission of the data frame if a voice packet becomes available before a significant portion of the data frame transmission has been completed. An early termination indicator is transmitted in place of the rest of the data and the receiver will consequently ignore this frame.

The transmitter buffer stores the data frame until the higher priority voice frame has been transmitted and then retransmits the data frame.

Using the example link speed of 200 kbit/s (common in satellite networks), with a “time slice” size of 40 ms, a “time slice” packet size can be calculated to be 1000 bytes which is less than the standard Ethernet MTU size of 1500 bytes and significantly smaller than the maximum network (IP) packet size of 64 kbytes. Therefore, excluding the variable network packet jitter, the maximum jitter for the received voice frames for the “time slice” case will be 40 ms, versus 60 ms for the Ethernet MTU size case and 2.56 s for the maximum network packet size case.

Although the invention has been described with reference to a particular example, it should be appreciated that many modifications and variations will be evident to the appropriately skilled person. For instance, data going into the network packet including any headers can be pre-compressed by any data compression method. A TCP acceleration method appropriate to the link used may also be applied prior to including data in the network packets. For example a satellite TCP performance enhancing proxy (PEP) may be used to improve the TCP performance over long delay links.

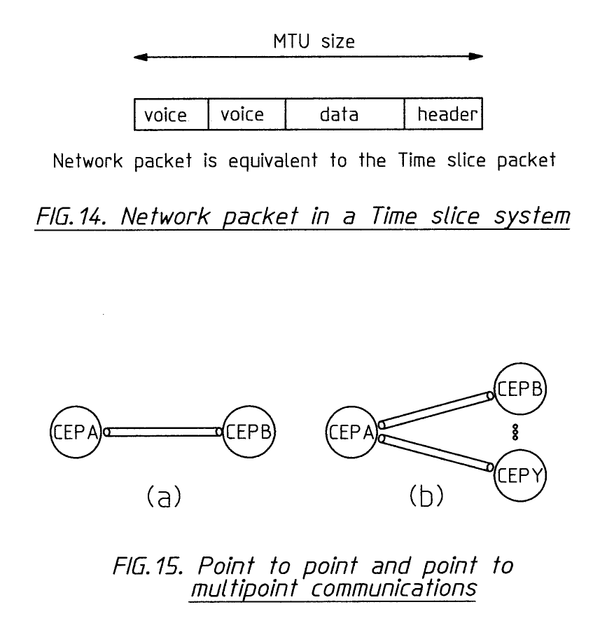

Also, the invention can be used in point to point 150 or in point to multipoint system 152 as seen in FIG. 15.

### REFERENCES

[1] RFC 3095—Robust Header Compression (ROHC): Framework and four profiles: RTP, UDP, ESP, and uncompressed, IETF

[2] Structure-Agnostic TDM over Packet (SAToP), draft-ietf-pwe3-satop-05.txt

[3] ICMP Path MTU Discovery Protocol, IETF RFC 1191 and RFC 1981

[4] “Method and apparatus for segmentation, reassembly and inverse multiplexing of packets and ATM cells over satellite/wireless networks”, Agarwal et al. U.S. Pat. No. 6,819,658, Nov. 16, 2004.

1. A method of generating packets for transmission over a packet based communications network, the method comprising the steps of:
determining a “time slice” packet size from the link speed and the interval of time extending between the times at which packets are selected for output from a buffer to the transmission interface;
creating a network packet from frames of time-critical data generated during the interval, where the packet is synchronized to both existing timing requirements of the time-critical frames and the link speed;
then, adding non time-critical data to the network packet if its size had not exceeded the determined “time slice” packet size.

2. A method according to claim 1, wherein the time-critical data is voice data.

3. A method according to claim 1, wherein the non time-critical data is a data stream.

4. A method according to claim 3, wherein, the non time-critical data is an existing network packet data stream.

5. A method according to claim 1, wherein the packet based communications system is a computer network.

6. A method according to claim 1, wherein the packet based communications system is a transmission link that includes a satellite link or some other rate limited radio channel.

7. A method according to claim 4, wherein the packets in the network packet data stream are Internet Protocol (IP) packets.

8. A method according to claim 1, wherein the “time slice” packet size is calculated from a running mean of the speed of the transmission of data across the network between the two end points.

9. A method according to claim 8, wherein, the “time slice” packet size is dynamically adjusted to current network conditions.

10. A method according to claim 1, wherein the time slice is estimated by a predictive technique.

11. A method according to claim 10, wherein the predictive technique includes a feedback component.

12. A method according to claim 1, wherein the time-critical and non time-critical communications are prioritized according to a priority queue.

13. A computer system for transmitting packets on a packet based communications system, wherein:
“time slice” packet size is dynamically determined from the link speed and the interval of time extending between the times at which packets are selected for output from a buffer to the transmission interface;
network packets are constructed from frames of time-critical data generated during the interval, where the packets are synchronized to both existing timing requirements of the time-critical frames and the link speed; then,
non time-critical data is added to the network packet if its size had not exceeded the determined “time slice” packet size.

14. Computer software for generating packets for transmission on a packet based communications system as claimed in claim 1.

15. A communications packet generated by the method according to claim 1, where the packet contains both time-critical and non time-critical data.
